(19) United States
(12) Patent Application Publication
(10) Pub. No.: US 2010/0057475 A1
(43) Pub. Date: Mar. 4, 2010

(54) METHOD AND SYSTEM FOR DIGITAL GAIN CONTROL IN AN AUDIO CODEC

(76) Inventors: Nelson Sollenberger, Farmingdale, NJ (US); Hongwei Kong, Denville, NJ (US)

Correspondence Address: MCANDREWS HELD & MALLOY, LTD, 500 WEST MADISON STREET, SUITE 3400, CHICAGO, IL, 60661, US

(21) Appl. No.: 12/248,626

(22) Filed: Oct. 9, 2008

Related U.S. Application Data
(60) Provisional application No. 61/091,905, filed on Aug. 26, 2008.

(51) Int. Cl. G10L 19/00

(52) U.S. Cl. 704/500; 704/E19.001

(57) ABSTRACT

Aspects of a method and system for digital gain control in an audio CODEC are provided. In this regard, in a hardware audio CODEC, a plurality of gain values in decibel format may be generated and may be summed to generate an overall gain value in decibels. Gain values may be ramped over a plurality of audio samples. The overall gain value in decibels may then be utilized to scale one or more audio signals. A first portion of the overall gain value in decibels may be converted to a scalar and a remaining portion of the overall gain value in decibels may be converted to a shift count. Accordingly, the scaling may comprise multiplying one or more audio signals by the scalar to generate one or more scaled audio signals and shifting the scaled audio signals by a number of bits equal to the shift count.

### CROSS-REFERENCE TO RELATED APPLICATIONS/INCORPORATION BY REFERENCE

This application makes reference to, claims priority to and claims benefit from U.S. Provisional Patent Application Ser. No. 61/091,905 filed on Aug. 26, 2008.

This application also makes reference to U.S. Provisional Patent Application Ser. No. 61/091,840 filed on Aug. 26, 2008.

Each of the above stated applications is hereby incorporated herein by reference in its entirety.

### FIELD OF THE INVENTION

Certain embodiments of the invention relate to processing of audio signals. More specifically, certain embodiments of the invention relate to a method and system for digital gain control in an audio CODEC.

### BACKGROUND OF THE INVENTION

In audio applications, systems that provide audio interface and processing capabilities may be required to support duplex operations, which may comprise the ability to collect audio information through a sensor, microphone, or other type of input device while at the same time being able to drive a speaker, earpiece of other type of output device with processed audio signal. In order to carry out these operations, these systems may comprise audio processing devices that provide appropriate gain, filtering, analog-to-digital conversion, and/or other processing of audio signals in an uplink direction and/or a downlink direction. In the downlink direction, an audio processing device may condition and/or process baseband audio signals from a receiver for presentation via audio output devices such as a loudspeaker and headphones. In an uplink direction, an audio processing device may process and/or condition audio signals received from an input device such as a microphone and convey the processed signals to a transmitter.

Limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for digital gain control in an audio CODEC, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary wireless system, which may be utilized in accordance with an embodiment of the invention.

FIG. 2A is a block diagram illustrating an exemplary audio processing device, in accordance with an embodiment of the invention.

FIG. 2B is a block diagram illustrating exemplary digital processing and analog processing portions of an audio processing device, in accordance with an embodiment of the invention.

FIG. 3A is a block diagram illustrating an exemplary digital gain block, in accordance with an embodiment of the invention.

FIG. 3B is a block diagram illustrating a digital gain block, in accordance with an embodiment of the invention.

FIG. 3C is a block diagram illustrating an exemplary gain ramping block, in accordance with an embodiment of the invention

FIG. 4 is a flowchart illustrating exemplary steps for controlling audio signal levels, in accordance with an embodiment of the invention.

### DETAILED DESCRIPTION OF THE INVENTION

Certain aspects of the invention may be found in a method and system for digital gain control in an audio CODEC. In various embodiments of the invention, in a hardware audio CODEC, a plurality of gain values in decibel format may be generated and may be summed to generate an overall gain value in decibels. The overall gain value in decibels may then be utilized to scale one or more audio signals. The overall gain value in decibels may be converted to an unsigned value in decibels and whether the gain corresponds to amplification or attenuation may be determined based on a sign of the overall gain value prior to the conversion. Each of the plurality of gain values may be generated via software, firmware, and/or hardware. A first portion of the overall gain value in decibels may be converted to a scalar and a remaining portion of the overall gain value in decibels may be converted to a shift count. Accordingly, the scaling may comprise multiplying one or more audio signals by the scalar to generate one or more scaled audio signals and shifting the one or more scaled audio signals by a number of bits equal to the shift count. The scalar value may be determined via a look-up table and may be selected from the look-up table based on whether the one or more audio signals are to be amplified or attenuated. The first portion of the overall gain value may comprise one or more least significant bits of the overall gain value in decibels. The remaining portion of the overall gain value may comprise one or more most significant bits of the overall gain value in decibels.

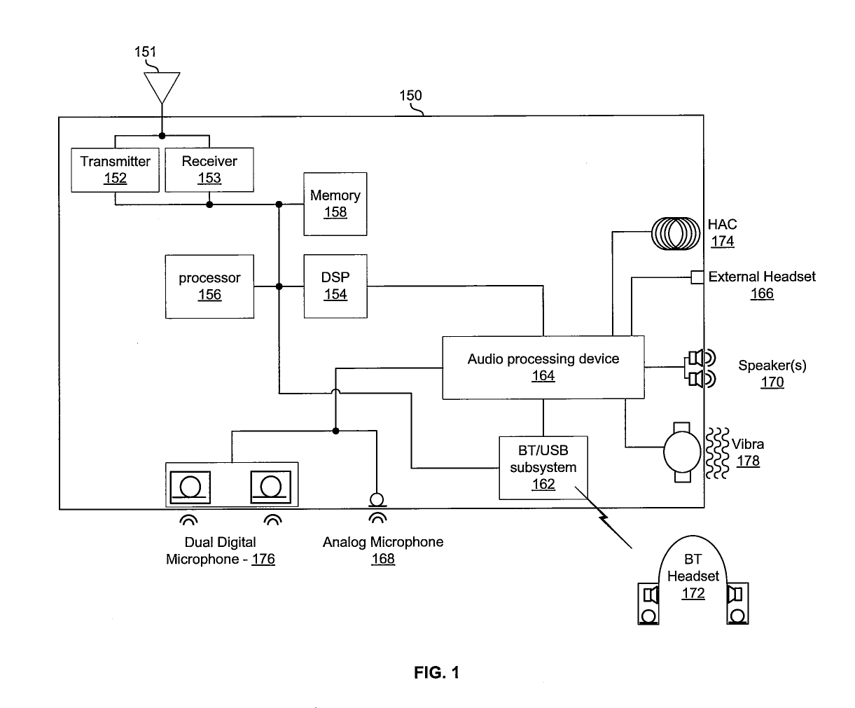

FIG. 1 is a block diagram of an exemplary wireless system, which may be utilized in accordance with an embodiment of the invention. Referring to FIG. 1, the wireless system 150 may comprise an antenna 151, a transmitter 152, a receiver 153, a digital signal processor 154, a processor 156, a memory 158, a Bluetooth (BT) and/or Universal Serial Bus (USB) subsystem 162, an audio processing device 164, an external headset port 166, an analog microphone 168, speaker(s) 170, a Bluetooth headset 172, a hearing aid compatibility (HAC) coil 174, a dual digital microphone 176, and a vibration transducer 178. The antenna 151 may be used for reception and/or transmission of RF signals. Different wireless systems may use different antennas for transmission and reception.

The transmitter 152 may comprise suitable logic, circuitry, and/or code that may be operable to modulate and up-convert baseband signals to RF signals for transmission by one or more antennas, which may be represented generically by the antenna 151. The transmitter 152 may be operable to execute other functions, for example, filtering the baseband and/or RF signals, and/or amplifying the baseband and/or RF signals. Although a single transmitter 152 is shown, the invention is not so limited. Accordingly, there may be a plurality of transmitters and/or receivers. In this regard, the plurality of transmitters may enable the wireless system 150 to handle a plurality of wireless protocols and/or standards including cellular, wireless local area networking (WLAN), and personal area networking (PAN). In addition, the transmitter 152 may be combined with the receiver 153 and implemented as a combined transmitter and receiver (transceiver).

The receiver 153 may comprise suitable logic, circuitry, and/or code that may be operable to down-convert and demodulate received RF signals to baseband signals. The RF signals may be received by one or more antennas, which may be represented generically by the antenna 151. The receiver 153 may be operable to execute other functions, for example, filtering the baseband and/or RF signals, and/or amplifying the baseband and/or RF signals. Although a single receiver 153 is shown, the invention is not so limited. Accordingly, there may be a plurality of receivers. In this regard, the plurality of receivers may enable the wireless system 150 to handle a plurality of wireless protocols and/or standards including cellular, WLAN, and PAN. In addition, the receiver 153 may be implemented as a combined transmitter and receiver (transceiver).

The DSP 154 may comprise suitable logic, circuitry, and/or code that may be operable to process audio signals. In various embodiments of the invention, the DSP 154 may encode, decode, modulate, demodulate, encrypt, and/or decrypt audio signals. In this regard, the DSP 154 may be operable to perform computationally intensive processing of audio signals.

The processor 156 may comprise suitable logic, circuitry, and/or code that may be operable to configure and/or control one or more portions of the system 150, control data transfers between portions of the system 150, and/or otherwise process data. Control and/or data information may be transferred between the processor 156 and one or more of the transmitter 152, the receiver 153, the DSP 154, the memory 158, the audio processing device 164, and the BT and/or USB subsystem 162. The processor 156 may be utilized to update and/or modify programmable parameters and/or values in one or more of the transmitter 152, the receiver 153, the DSP 154, the memory 158, the audio processing device 164, and the BT and/or USB subsystem 162. In this regard, a portion of the programmable parameters may be stored in the system memory 158. The processor 156 may be any suitable processor or controller. For example, the processor may be a reduced instruction set computing (RISC) microprocessor such as an advanced RISC machine (ARM), advanced virtual RISC (AVR), microprocessor without interlocked pipeline stages (MIPS), or programmable intelligent controller (PIC).

The system memory 158 may comprise suitable logic, circuitry, and/or code that may be operable to store a plurality of control and/or data information, including parameters needed to configure one or more of the transmitter 152, the receiver 153, the DSP 154, and/or the audio processing device 164. The system memory 158 may store at least a portion of the programmable parameters that may be manipulated by the processor 156.

In an exemplary embodiment of the invention, the DSP 154 and processor 156 may exchange audio data and control information via the memory 158. For example, the processor 156 may write encoded audio data, such as MP3 or AAC audio, to the memory 158 and the memory may pass the encoded audio data to the DSP 154. Accordingly, the DSP 154 may decode the data and write pulse-code modulated (PCM) audio back into the shared memory for the processor 156 to access and/or to be delivered to the audio processing device 164.

The BT and/or USB subsystem 162 may comprise suitable circuitry, logic, and/or code that may be operable to transmit and receive Bluetooth and/or Universal Serial Bus (USB) signals. The BT and/or USB subsystem 162 may be operable to up-convert, down-convert, modulate, demodulate, and/or otherwise process BT and/or USB signals. In this regard, the BT and/or USB subsystem 162 may handle reception and/or transmission of BT and/or USB signals via a wireless communication medium and/or handle reception and/or transmission of USB signals via a wireline communication medium. Information and/or data received via a BT and/or USB connection may be communicated between the BT and/or USB subsystem 162 and one or more of the transmitter 152, the receiver 153, the DSP 154, the processor 156, the memory 158, and the audio processing device 164. For example, the BT and/or USB subsystem 162 may extract audio from a received BT and/or USB signal and may convey the audio to other portions of the wireless system 150 via an inter-IC sound (I²S) bus. Information and/or data may be communicated from one or more of the transmitter 152, the receiver 153, the DSP 154, the processor 156, the memory 158, and the audio processing device 164 to the BT and/or USB subsystem 162 for transmission over a BT and/or USB connection. For example, audio signals may be received from other portions of the wireless system 150 via an 12S bus and the audio signal may be transmitted via a BT and/or USB connection. Additionally, control and/or feedback information may be communicated between the BT and/or USB subsystem 162 and one or more of the transmitter 152, the receiver 153, the DSP 154, the processor 156, the memory 158, and the audio processing device 164.

The audio processing device 164 may comprise suitable circuitry, logic, and/or code that may be operable to process audio signals received from and/or communicated to input and/or output devices. The input devices may be within or communicatively coupled to the wireless device 150, and may comprise, for example, the analog microphone 168, the stereo speakers 170, the Bluetooth headset 172, the hearing aid compatible (HAC) coil 174, the dual digital microphone 176, and the vibration transducer 178. The audio processing device 164 may up-sample and/or down-sample audio signals to one or more desired sample rates for communication to an audio output device, the DSP 154, and/or the BT and/or USB subsystem 162. In this regard, the audio processing device 164 may also be enabled to handle a plurality of data sampling rate inputs. For example, the audio processing device 164 may accept digital audio signals at sampling rates such as 8 kHz, 11.025 kHz, 12 kHz, 16 kHz, 22.05 kHz, 24 kHz, 32 kHz, 44.1 kHz, and/or 48 kHz. The audio processing device 164 may be enabled to handle a plurality of digital audio inputs of various resolutions, such as 16 or 18-bit resolution, for example. The audio processing device 164 may support mixing of a plurality of audio sources. For example, the audio processing device 164 may support audio sources such as general audio, polyphonic ringer, I²S FM audio, vibration driving signals, and voice. In an exemplary embodiment of the invention, the general audio and polyphonic ringer sources may support the plurality of sampling rates that the audio processing device 164 may be enabled to accept, while the voice source may support a portion of the plurality of sampling rates, such as 8 kHz and 16 kHz.

The audio processing device 164 may utilize a programmable infinite impulse response (IIR) filter and/or a programmable finite impulse response (FIR) filter for at least a portion of the audio sources to compensate for passband amplitude and phase fluctuation for different input and/or output devices. In this regard, filter coefficients may be configured or programmed dynamically based on operations. Moreover, filter coefficients may all be switched in one-shot or may be switched sequentially, for example. The audio processing device 164 may also utilize a modulator, such as a Delta-Sigma (ΔΣ) modulator, for example, to code digital output signals for analog processing. The audio processing device 164 may be referred to, for example, as an audio coding and/or decoding device or CODEC. In various embodiments of the invention, the audio processing device 164 may be implemented in dedicated hardware.

The external headset port 166 may comprise a physical connection for an external headset to be communicatively coupled to the wireless system 150. The headset may, for example, be an analog headset comprising a microphone and a pair of stereo transducers. Alternatively, the headset may be a digital headset which may utilize a protocol such as USB for communicating audio information.

The analog microphone 168 may comprise suitable circuitry, logic, and/or code that may detect sound waves and convert them to electrical signals via a piezoelectric effect, for example. The electrical signals generated by the analog microphone 168 may comprise analog signals that may require analog to digital conversion before processing.

The one or more speakers 170 may be operable to generate acoustic waves from electrical signals received from the audio processing device 164. In an exemplary embodiment of the invention, there may be a pair of speakers which may be operable to output acoustic waves corresponding to, for example, left and right stereo channels.

The Bluetooth headset 172 may comprise a wireless headset that may be communicatively coupled to the wireless system 150 via the BT and/or USB subsystem 162. In this manner, the wireless system 150 may be operated in a hands-free mode, for example.

The HAC coil 174 may comprise suitable circuitry, logic, and/or code that may enable communication between the wireless device 150 and a hearing aid, for example. In this regard, audio signals may be magnetically coupled from the HAC coil 174 to a coil in a user's hearing aid.

The dual digital microphone 176 may comprise suitable circuitry, logic, and/or code that may detect sound waves and convert them to electrical signals. The electrical signals generated by the dual digital microphone 176 may comprise digital signals, and thus may not require analog to digital conversion prior to digital processing in the audio processing device 164.

The vibration transducer 178 may comprise suitable circuitry, logic, and/or code that may be operable to notify a user of events on the wireless device 150 such as calendar reminders, a low battery notification, a received signal strength notification, an incoming call, and an incoming message without the use of sound. Aspects of the invention may enable the vibration transducer 178 to generate vibrations that may be in synch with, for example, audio signals such as speech, music, ringtones, and/or continuous wave (CW) tones.

In operation, audio signals from the receiver 153, the processor 156, and/or the memory 158 may be conveyed to the DSP 154. The DSP 154 may process the signals to generate output baseband audio signals to the audio processing device 164. Additionally, baseband audio signals may be conveyed from the BT and/or USB subsystem 162, the analog microphone 168, and/or the digital microphone 176, to the audio processing device 164.

The audio processing device 164 may process and/or condition one or more of the baseband audio signals to make them suitable for conveyance to the one or more speakers 170, the headset 166, the HAC 174, the vibration transducer 178, the transmitter 152, and/or the BT and/or USB subsystem 162. Processing and/or conditioning of audio signals by the audio processing device 164 may comprise amplifying and/or attenuating audio signal levels via one or more digital gain blocks. In this regard, an overall gain, whether amplification or attenuation, of each digital gain block may be a sum of a plurality of components. In an exemplary embodiment of the invention, a first component of the overall gain may be determined via software and/or firmware implemented in the DSP 154, the processor 156, and/or the memory 158, and the second component of the overall gain may be determined in hardware of the audio processing device 164. In various embodiments of the invention, adjustments of the overall gain may be applied incrementally over one or more audio samples. In this manner, audible clicking or popping, for example, which may result from rapid and/or large audio signal level changes, may be prevented by ramping up and/or ramping down the overall gain until a target gain is achieved.

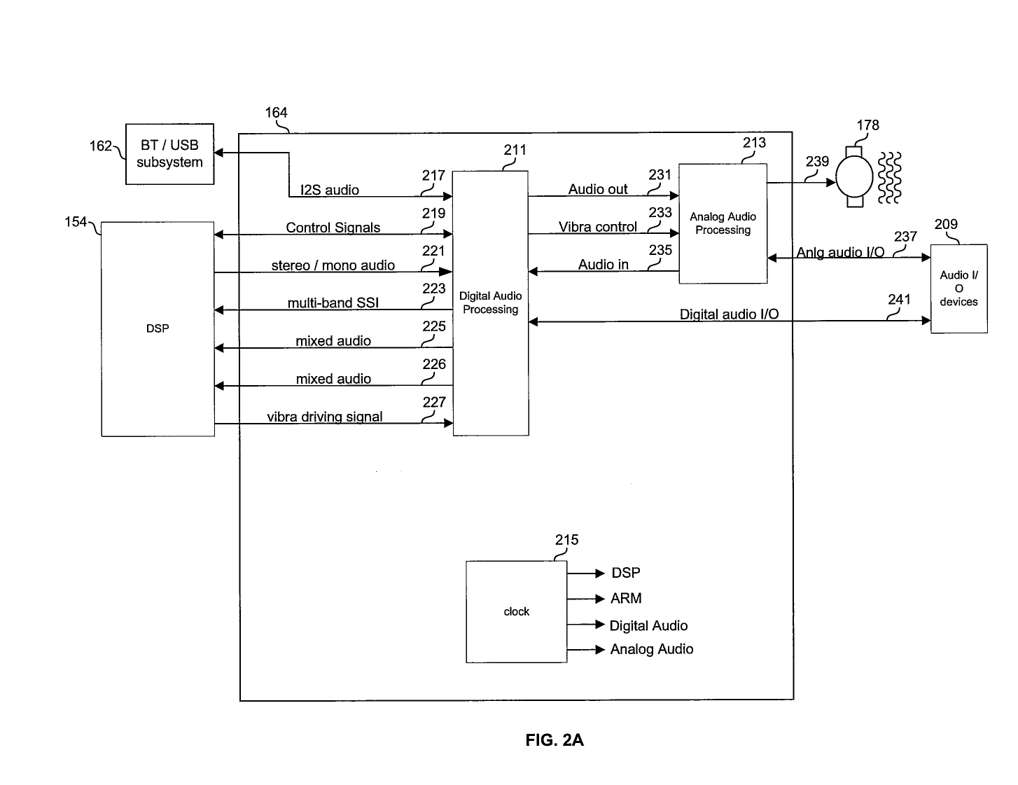

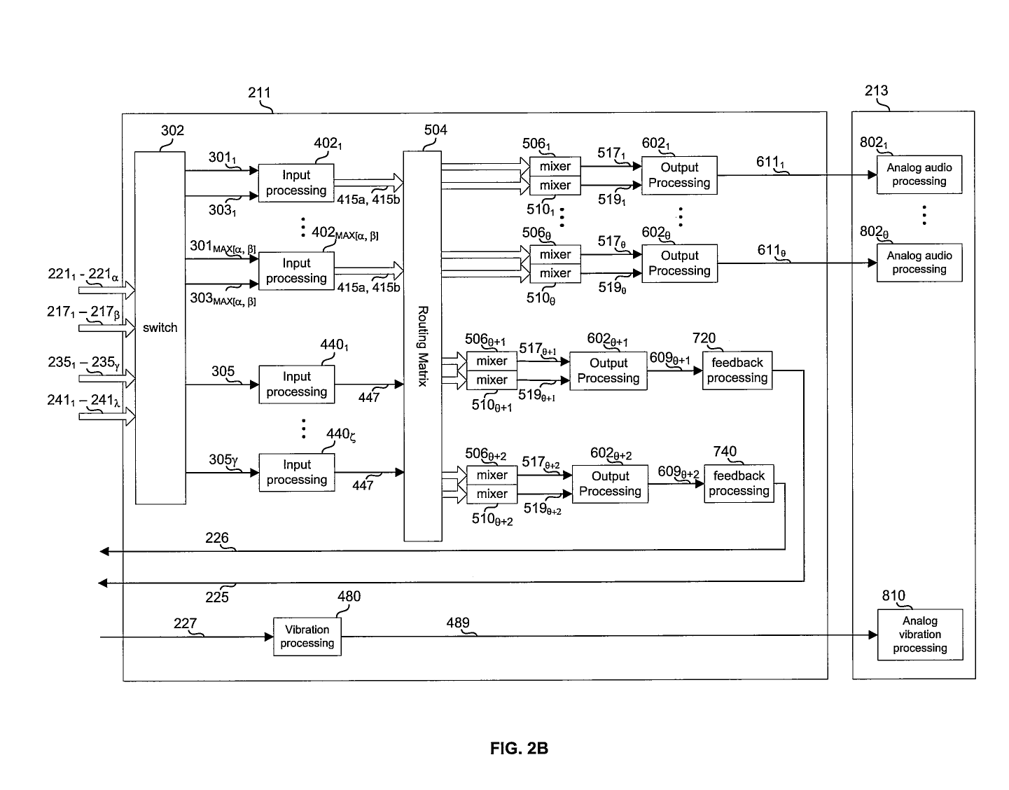

FIG. 2A is a block diagram illustrating an exemplary audio processing device, in accordance with an embodiment of the invention. Referring to FIG. 2A, there is shown the DSP 154, the BT and/or USB subsystem 162, the audio processing device 164, and audio input and/or output devices 209. The audio input and/or output devices 209 may comprise one or more devices such as the external headset port 166, the analog microphone 168, the speakers 170, the Bluetooth headset 172, the hearing aid compatibility (HAC) coil 174, the dual digital microphone 176, and the vibration transducer 178 described with respect to FIG. 1. The DSP 154 and the BT and/or USB subsystem 162 may be as described with respect to FIG. 1. The audio processing device 164 may be as described with respect to FIG. 1 and may comprise a digital portion 211, an analog portion 213, and a clock 215.

The digital portion 211 may comprise suitable logic, circuitry, and/or code that may enable processing audio signals in the digital domain. In this regard, the digital portion 211 may be operable to filter, buffer, up-sample, down-sample, apply a digital gain to, route, and/or otherwise condition digital audio signals. Additional details of the digital portion 211 are described below with respect to FIGS. 2B, 3A, 3B, and 4.

The analog portion 213 may comprise suitable logic, circuitry, and/or code that may enable conversion of digital audio signals to an analog representation and amplifying and/or buffering the analog signals for driving audio output devices. Additional details of the analog portion 213 are described below with respect to FIG. 2B.

The clock 215 may comprise suitable logic, circuitry, and/or code that may be operable to generate one or more periodic signals. The clock 215 may, for example, comprise one or more crystal oscillators, phase locked loops (PLLs), and/or direct digital frequency synthesizers (DDFS). The clock 215 may output a plurality of signals each with a distinct frequency and/or phase. The signals output by the clock 215 may be conveyed to one or more of the digital portion 211, the analog portion 213, the DSP 154, the memory 158, and/or the processor 156.

In various exemplary embodiments of the invention, one or more audio signals 217 may be communicated between the digital portion 211 and the BT and/or USB subsystem 162 via an inter-IC sound (I²S) bus. Each of the audio signals 217 may be a monaural channel, a left stereo channel, or a right stereo channel. In an exemplary embodiment of the invention, the BT and/or USB subsystem 162 may be enabled to receive and/or process audio broadcasts, and thus, two signals 217 comprising left and right channel audio may be conveyed to the digital portion 211 via an I²S bus. In this regard, exemplary audio broadcasts may comprise FM stereo, “HD radio”, DAB, DAB+, and satellite radio broadcasts.

In various exemplary embodiments of the invention, one or more output audio signals 231, vibration control 233, and input audio signals 235 may be communicated between the digital portion 211 and the analog portion 213.

The output audio signals 231 may each comprise one or more digital audio signals which have been suitably processed and/or conditioned by the digital portion 211 for output via one or more of the audio output devices 209. Each of the audio signals 231 may be a monaural channel, a left stereo channel, or a right stereo channel. Each of the output audio signals 231 may be converted to an analog representation and amplified by the analog portion 213.

The input audio signals 235 and 241 from an audio input device 209 may each comprise one or more digital audio signals to be processed by the digital portion 211. The input audio signals 235 and/or 241 may comprise monaural and/or stereo audio data which the digital portion 211 may process for conveyance to the DSP 154 and subsequent transmission to a remote wireless device. The input audio signals 235 and/or 241 may comprise monaural and/or stereo audio data which the digital portion 211 may process in a “loopback” path for conveyance to one or more audio output devices 209.

The vibration control signal 233 may be a pulse width modulated square wave that may, after being amplified by the analog portion 213, control vibration of the vibration transducer 178. In various exemplary embodiments of the invention, spectral shaping techniques may be applied in the pulse width modulation function to reduce noise in the audible band.

In various exemplary embodiments of the invention, one or more control signals 219, one or more audio signals 221, one or more SSI signals 223, one or more mixed audio signals 225 and/or 226, and one or more signals 227 for driving a vibration transducer may be communicated between the DSP 154 and the digital portion 211. Monaural and/or stereo audio data may be extracted from RF signals received by the receiver 153 and processed by the DSP block 154 before being conveyed to the digital portion 211 of the processing device 164. One or more signals communicated between the DSP 154 and the digital portion 211 may be buffered. For example, voice signals may not be buffered while music and/or ringtone signals may be written to a first-in-first-out (FIFO) buffer by the DSP 154 and then fetched from the FIFO by the digital portion 211.

The one or more control signals 219 may be utilized to configure various operations of the digital portion 211 based, for example, on a resolution and/or sampling rate of signals being output by the DSP 154. In various embodiments of the invention, one or more control registers for the digital portion 211 may reside in the DSP 154. In various embodiments of the invention, the control signals 219 may comprise one or more interrupt signals.

The audio signals 221 may each comprise, for example, voice data, music data, or ringtone data. Each audio signal 221 may be monaural signal, a left stereo channel, or a right audio channel. The digital portion 211 may condition and/or process the audio signals 221 for conveyance to one or more audio output devices and/or uplink paths. In various embodiments of the invention, the resolution and/or sample rate of the audio signals 221 may vary. Exemplary resolutions may comprise 16-bit and 18-bit resolution. Exemplary sample rates may comprise 8 kHz, 11.05 kHz, 12 kHz, 16 kHz, 22.05 kHz, 24 kHz, 32 kHz, 44.1 kHz, and 48 kHz.

The signal strength indicator (SSI) signals 223 may comprise one or more feedback signals from the digital portion 211 to the DSP 154. The SSI signals 223 may provide an indication of signal strength of one or more frequency bands of one or more audio signals 221, 225, and/or 226. The SSI signals 223 may, for example, be utilized by the DSP 154, the processor 156, the memory 158, or a combination thereof to control a digital gain applied to each sub-band of one or more audio signals 221, 225, and/or 226. In various embodiments of the invention, the SSI signals 223 may be utilized for audio visualizations.

The signal 227 may comprise audio data utilized to control a vibration transducer 178. The signal 227 may comprise, for example, CW tone data, voice data, music data, or ringtone data. Characteristics such as intensity of vibration, a pattern in which vibration is started and stopped, a frequency at which vibration may be started and/or stopped, and/or a duration of a vibration or sequence of vibrations may be controlled based on the signal 227.

The one or more mixed audio signals 225 and the one or more mixed audio signals 226 may be output by the digital portion 211 to the DSP 154. The mixed audio signals 225 may each be a composite signal comprising information from one or more monaural signals and/or stereo audio signals. Similarly, the mixed audio signals 226 may each be a composite signal comprising information from one or more monaural signals and/or stereo audio signals. In this regard, one or more of the audio signals 221, one or more of the input audio signals 235, one or more of the input audio signals 241, and/or one or more of the audio signals 217 may be mixed together. Each of the audio signals 221, 235, 241, and 217 may be, for example, amplified, attenuated, band limited, up-converted, down-converted or otherwise processed and/or conditioned prior to mixing. The mixed audio signals 225 may be part of and/or coupled to an uplink path. For example, the signals 225 may be processed by the DSP 154 and transmitted, via the BT and/or USB subsystem 162, to a remote wireless system. Similarly, the mixed audio signal) 226 may be part of and/or coupled to an uplink path. For example, the signals 226 may be processed by the DSP 154 and transmitted, via the transmitter 152, to a far-end communication partner or a remote wireless system.

In operation, one or more baseband audio signals 217, 221, 235, and/or 241 may be conveyed to the audio processing device 164 from one or more of the DSP 154, the BT and/or USB subsystem 162, and the input and/or output devices 209. The digital portion 211 of the audio processing device 164 may select which baseband audio signals 221 to process. Each of the selected audio signals may be processed based on factors such as whether the signal is one of a pair of stereo signals or is a monaural signal; whether the signal comprises voice, music, or ringtone data; a resolution of the signal; and a sample rate of the signal. Selected audio signals may be processed in an input processing path comprising one or more input audio processing blocks 402 and/or 440 (FIG. 2B). The input audio processing path may be operable to process and/or condition audio signals based on a source and/or various characteristics of the audio signal. Subsequently, audio signals may be mapped from one or more input processing paths to one or more output processing paths. In this regard, conditioning of audio signals by the input processing path may comprise adjusting a gain of one or more digital gain blocks in order to maintain signal levels between determined thresholds. The output processing path may comprise one or more mixers 506 and/or 510 (FIG. 2B), output audio processing blocks 602 (FIG. 2B), feedback audio processing block 720 (FIG. 2B), and/or feedback processing block 740 (FIG. 2B). The output processing path may condition signals based on one or more output devices 209 and/or uplink paths to which the audio signals may be conveyed. In this regard, conditioning of audio signals by the output processing path may comprise adjusting a gain of one or more digital gain blocks in order to maintain levels of signals between determined thresholds.

FIG. 2B is a block diagram illustrating exemplary digital processing and analog processing portions of an audio processing device, in accordance with an embodiment of the invention. Referring to FIG. 2B, there is shown a digital portion 211 and an analog portion 213.

The digital portion 211 may comprise a switching element 302, a plurality of input audio processing blocks 402, a plurality of input audio processing blocks 440, a digital vibration processing block 480, a routing matrix 504, a plurality of mixers 506 and 510, a plurality of output audio processing blocks 602, a feedback audio processing block 720, and a feedback audio processing block 740.

The switching element 302 may be operable to route one or more of the signals 221₁ . . . 221_{α} (collectively referred to herein as signals 221), 217₁ . . . 217_{β} (collectively referred to herein as signals 217), 235₁ . . . 235_{γ} (collectively referred to herein as signals 235), and/or 241₁ . . . 241_{λ} (collectively referred to herein as signals 241) from the DSP 154, BT and/or USB subsystem 162, and audio input devices 209 to the digital portion 211, where α, β, γ and λ are integers greater than or equal to 1. Which signals 221, 217, 235, and/or 241 are routed to the one or more input audio processing blocks 402 and/or 440 may be determined based on one or more control signals received from, for example, the DSP 154, the processor 156, and/or the BT and/or USB subsystem 162. In this regard, the switching element 302 may be configured dynamically and/or in real-time so as to provide processing whenever it may be required.

Each of the input audio processing blocks 402 may comprise suitable logic, circuitry, and/or code that may be operable to condition monaural or stereo input audio signals. Processing of an audio signal by each of the input audio processing blocks 402 may be based on a type of audio content in the signal, a source of the audio signal, and/or a sample rate of the audio signal. Each of the input audio processing blocks 402 may be operable to buffer an audio signal 301 and/or 303. One or more of the input audio processing blocks 402 may be operable to control whether audio data is processed as a left stereo channel, a right stereo channel, or a monaural signal. Each of the input audio processing blocks 402 may be operable to measure strength of one or more audio signals 301 and/or 303 and generate one or more feedback signals corresponding to the measured strength. Each of the input audio processing blocks 402 may be operable to filter the one or more audio signals 301 and/or 303, and/or up-sample and/or down-sample the audio signals 301 and/or 303. Each of the input audio processing blocks 402 may be operable to adjust signal levels of the signals 415a and 415b. In this regard, an overall gain of one or more digital gain blocks within each of the input audio processing blocks 402 may be a sum of a plurality of components provided via software, firmware, and/or hardware. In various embodiments of the invention, one or more of the input audio processing blocks 402 may be configured via one or more control signals received from, for example, the DSP 154, the processor 156, and/or the BT and/or USB subsystem 162. In this regard, the input audio processing blocks 402 may be configured dynamically and/or in real-time so as to provide processing whenever it may be required.

Each of the input audio processing blocks 402 may comprise suitable logic, circuitry, and/or code that may be operable to condition monaural input audio signals. Processing of an audio signal 305 by each of the input audio processing blocks 402 may be based on a type of audio content in the signal 305, a source of the audio signal 305, and/or a sample rate of the audio signal 305. Each of the audio processing blocks may be operable to buffer an audio signal 305, filter the audio signal 305, and/or up-sample or down-sample the audio signal 305. Each of the input audio processing blocks 402 may be operable to adjust signal levels of the signal 447. In this regard, an overall gain of one or more digital gain blocks within each of the input audio processing blocks 402 may be a sum of a plurality of components provided via software, firmware, and/or hardware. In various embodiments of the invention, one or more of the input audio processing blocks 402 may be configured via one or more control signals received from, for example, the DSP 154, the processor 156, and/or the BT and/or USB subsystem 162. In this regard, the input audio processing blocks 402 may be configured dynamically and/or in real-time so as to provide processing whenever it may be required.

The digital vibration processing block 480 may comprise suitable logic, circuitry, and/or code that may be operable to process and/or condition one or more of the baseband audio signals to generate one or more signals 489 for controlling the vibration transducer 178. In this regard, the digital vibration processing block 480 may be operable to control vibrations based on an audio signal. In an exemplary embodiment of the invention, various characteristics such as intensity of vibration, a pattern in which vibration is started and stopped, a frequency at which vibration is started and stopped, and/or duration of a vibration or sequence of vibrations may be controlled based on an audio signal input to the digital vibration processing block 480. The digital vibration processing block 480 may be operable to adjust signal levels of the signal 489. In this regard, an overall gain of one or more digital gain blocks within the digital vibration processing block 480 may be a sum of a plurality of components provided via software, firmware, and/or hardware. The digital vibration processing block 480 may be configured via one or more control signals received from, for example, the DSP 154, the processor 156, and/or the BT and/or USB subsystem 162. In this regard, the digital vibration processing block 480 may be configured dynamically and/or in real-time so as to provide processing whenever it may be required.

The routing matrix 504 may comprise suitable logic, circuitry, and/or code that may be operable to route each of the signals 415 and 447 to one or more of the mixers 506 and/or 510. The routing matrix 504 may be configured via one or more control signals from, for example, the processor 156, the DSP 154, and/or the memory 158. Moreover, configuration of the routing matrix 504 may occur dynamically and/or in real-time so as to provide processing whenever it may be required. In various embodiments of the invention, the routing matrix 504 may comprise one or more multiplexers or similar switching elements. Routing of each input signal 415 and/or 447 may depend, at least in part, on an output device 209 and/or uplink path for which each signal 415 and 447 may be destined. In this regard, the routing and re-routing of signals between inputs and outputs of the audio processing device 164 may occur in real-time.

Routing of each input signal 415 and/or 447 may be independent of the routing of other input signals 415 and 447, independent of the source of each signal 415 and/or 447, and independent of whether each signal 415 and/or 447 is a stereo channel or a monaural channel. Thus, upstream from the routing matrix 504 audio signals may be processed according to an input of the processing device 164 on which the audio signals where received and downstream from the routing matrix 504 audio signals may be processed based on an output of the processing device 164 for which the signals are destined. In this manner, the processing device 164 may provide flexibility in routing audio signals of various types from various sources to one or more audio output devices and/or uplink paths. Upstream from the routing matrix 504 may comprise the input audio processing blocks 402 and 440. Downstream from the routing matrix 504 may comprise the mixers 506 and 510, the output audio processing blocks 602, the feedback audio processing block 720, and the feedback audio processing block 740.

The mixers 506 and 510 may each comprise suitable logic, circuitry, and/or code that may be operable to combine audio signals into a composite audio signal. Each mixer 506 may combine up to η audio signals to generate a composite audio signal 517. Similarly each mixer 510 may combine up to η audio signals to generate a composite audio signal 519. In various embodiments of the invention, each signal 517₁ . . . 517_{θ+2}, may be a left stereo channel and each signal 519₁ . . . 519_{θ+2}, may be a right stereo channel. In an exemplary embodiment of the invention, the mixers 506 and 510 may output up to θ+2 stereo signals or up to 2(θ+2) monaural signals to a number, θ, of analog audio processing blocks 802, the feedback audio processing block 720, and the feedback audio processing block 740 via the output audio processing blocks 602. The mixers 506 and 510 may be configured via one or more control signals from, for example, the processor 156, the DSP 154, and/or the memory 158. In this regard, the mixers 506 and/or 510 may be configured dynamically and/or in real-time so as to provide processing whenever it may be required.

Each output audio processing blocks 602 may comprise suitable logic, circuitry, and/or code that may be operable to process audio signals for conveyance to one or more analog audio processing blocks 802, the feedback audio processing block 720, and the feedback audio processing block 740. Each output processing block may be operable to filter, up-sample, and ΔΣ modulate audio signals. Additionally, each output audio processing block 602 may be operable to control a gain applied to the signals. In this regard, an overall gain of one or more digital gain blocks within one or more output audio processing blocks 602 may be a sum of a plurality of components provided via software, firmware, and/or hardware.

The feedback audio processing block 720 may comprise suitable logic, circuitry, and/or code that may be operable to process and/or condition one or more of the baseband audio signals to generate one or more signals 225. In various embodiments of the invention, one or more signals 225 may be conveyed to an uplink signal path via the DSP 154 and/or the BT and/or USB subsystem 162. In this regard, the audio signal(s) 225 may comprise voice, music, and/or ringtone data which may be communicated to a remote wireless device utilizing BT and/or USB protocols. In various embodiments of the invention, one or more signals 225 may be conveyed to an output device such as the BT headset 172 via the BT and/or USB subsystem 162. The feedback audio processing block 720 may be operable to up-sample and/or down-sample audio signals. The feedback audio processing block 720 may be operable to adjust levels of the composite audio signal(s) 225. In this regard, an overall gain of one or more digital gain blocks within feedback audio processing block 720 may be a sum of a plurality of components provided via software, firmware, and/or hardware. The feedback audio processing block 720 may be configured via one or more control signals received from, for example, the DSP 154, the processor 156, and/or the BT and/or USB subsystem 162. In this regard, the feedback audio processing block 720 may be configured dynamically and/or in real-time so as to provide processing whenever it may be required.

The feedback audio processing block 740 may comprise suitable logic, circuitry, and/or code that may be operable to process and/or condition one or more baseband audio signals to generate one or more signals 226 which may be conveyed to an uplink signal path via the DSP 154 and/or transmitter 152. In this regard, the audio signal 226 may comprise voice, music, and/or ringtone data which may be communicated to a remote wireless device utilizing, for example, cellular, WLAN, and/or PAN protocols. The feedback audio processing block 740 may be operable to up-sample and/or down-sample audio signals. The feedback audio processing block 740 may be operable to adjust levels of the composite audio signal(s) 226. In this regard, an overall gain of one or more digital gain blocks within one or more analog audio processing blocks 802 may be a sum of a plurality of components provided via software, firmware, and/or hardware. The feedback audio processing block 740 may be configured via one or more control signals received from, for example, the DSP 154, the processor 156, and/or the BT and/or USB subsystem 162. In this regard, the feedback audio processing block 740 may be configured dynamically and/or in real-time so as to provide processing whenever it may be required.

Each of the analog audio processing blocks 802 may comprise suitable logic, circuitry, and/or code that may be operable to condition audio signals for driving an audio output device 209. Each analog audio processing block 802 may be operable to convert a digital audio signal to an analog representation. Each analog audio processing block 802 may be operable to buffer and/or amplify analog audio signals for driving an audio output device 209. In this regard, an overall gain of one or more digital gain blocks within one or more analog audio processing blocks 802 may be a sum of a plurality of components provided via software, firmware, and/or hardware. The analog audio processing blocks 802 may be configured via one or more control signals which may be received from, for example, the DSP 154, the processor 156, and/or the BT and/or USB subsystem 162. In this regard, the analog audio processing blocks 802 may be configured dynamically and/or in real-time so as to provide processing whenever it may be required.

The analog vibration processing block 810 may comprise suitable logic, circuitry, and/or code that may be operable to buffer and/or amplify the signal 489 for driving the vibration transducer 178. In this regard, driving the vibration transducer 178 may require more current than the digital vibration processing block 480 may be able to output and thus the analog vibration processing block 810 may provide increased output current for driving the vibration transducer 178. The analog vibration processing block 810 may be configured via one or more control signals received from, for example, the DSP 154, the processor 156, and/or the BT and/or USB subsystem 162. In this regard, the analog vibration processing block 810 may be configured dynamically and/or in real-time so as to provide processing whenever it may be required.

In operation, the switching element 302 may select one or more audio signals to be routed to one or more of the input audio processing blocks 402 and/or the input audio processing blocks 402. Each of the input audio processing blocks 402 and/or 440 may condition audio signals and convey them to the routing matrix 504. The routing matrix 504 may route the audio signals to one or more mixers 506 and/or 510. Each of the mixers 506 and/or 510 may be operable to mix together one or more audio signals into a composite audio signal 517 and/or 519. The signals 517 and/or 519 may each be conveyed to an output audio processing block 602. Each of the output audio processing blocks 602 may condition audio signals for conveyance to an analog audio processing block 802, the feedback audio processing block 720, or the feedback audio processing block 740. The signals 611₁, . . . , 611_{θ} may each be conveyed to an analog processing block 802 which may convert the signals 611₁, . . . , 611_{θ} to an analog representation and buffer and/or amplify the analog audio signal to drive an audio output device 209. The signal 609_{θ+1} may be conveyed to the feedback audio processing block 720 which may process and/or condition the signal 609_{θ+1} for transmission to a remote wireless device. The signal 609_{θ+2} may be conveyed to the feedback audio processing block 740 which may condition the signal 609_{θ+2} for transmission to a remote wireless device.

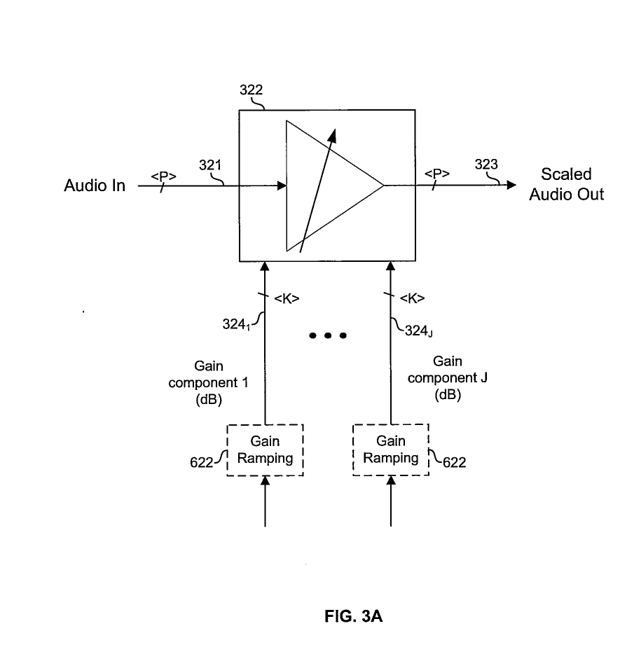

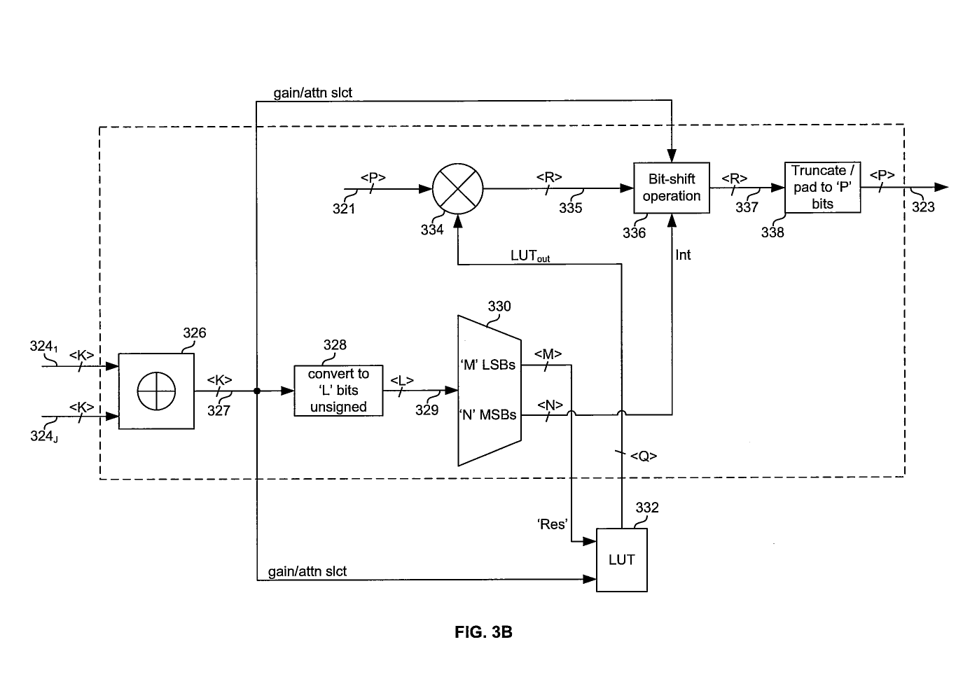

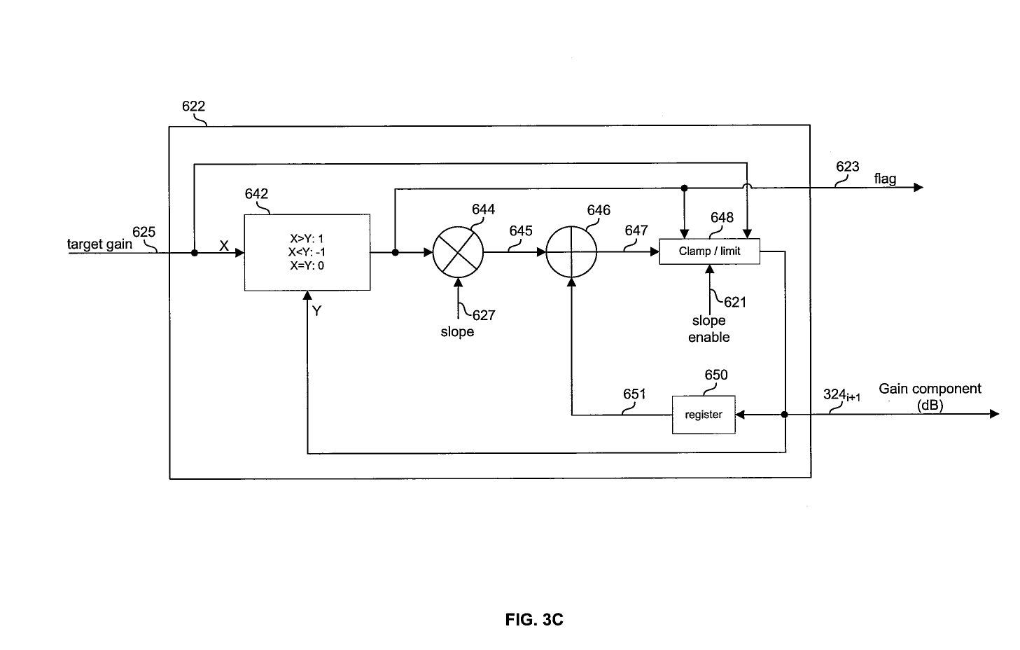

FIG. 3A is a block diagram illustrating an exemplary digital gain block, in accordance with an embodiment of the invention. Referring to FIG. 3A, there is shown a digital gain block 322.

The digital gain block 322 may comprise suitable logic, circuitry, and/or code that may be operable to scale audio signal 321 to generate audio signal 323. In this regard, the audio signal 321 may be scaled based on an overall gain determined by summing the gain components 324₁, . . . , 324_{J}.

The gain components 324₁, . . . , 324_{J} may be a gain in decibels (dB). In this regard, storing the gain components in dB may enable adding the components to determine the overall gain of the digital gain block 322.

In various embodiments of the invention, one or more of the gain components 324 may be controlled via a gain ramping block. In this regard, each of the gain ramping blocks 622 may comprise suitable logic, circuitry, and/or code that may be operable to incrementally increase or decrease the gain components 324 over a plurality of samples.

In operation, the gain components 324₁, . . . , 324_{J} may be generated by the gain ramping blocks 622 and conveyed to the digital gain block 322. Target gains 625 input to gain ramping blocks 622 may be supplied via hardware, firmware, and/or software within the wireless device 150. The gain ramping blocks 622 may ramp up or down the gain components 324 until the gain components 324 may be equal to, or within a tolerance of, the target gains 625. The gain components 324 may be ramped up or down over many audio samples instead of changing the gain components 324 to the target gain 625 instantly at the time the target gains are provided. Ramping the gain components may prevent audible clicking and/or popping noise which may result from abrupt gain changes in an audio signal. The digital gain block 322 may sum the components to determine the overall gain in dB, and then scale the audio signal 321 by the overall gain to generate the audio signal 323.

FIG. 3B is a block diagram illustrating a digital gain block, in accordance with an embodiment of the invention. Referring to FIG. 3B, the digital gain block 322 may comprise an adder 326, a number conversion block 328, a routing block 330, a multiplier 334, a bit-shift operation 336, a number conversion block 338. The digital gain block 322 may additionally utilize a look-up table (LUT) 332 which may, for example, be stored in the system memory 158.

The adder 326 may comprise suitable logic, circuitry, and/or code that may be operable to add the gain components 324 to generate an overall gain 327. The overall gain 327 may be stored as a dB value.

The number conversion block 328 may comprise suitable logic, circuitry, and/or code that may be operable to convert the overall gain 327 from a K-bit signed signal to an L-bit unsigned signal 329. The modified overall gain 329 may be stored as a dB value.

The routing block 330 may comprise suitable logic, circuitry, and/or code that may be operable to route the ‘M’ least significant bits of the modified overall gain 329 to the LUT 332 and the ‘N’ most significant bits of the modified overall gain 329 to the shift bit-shift operation 336, where ‘M’+‘N’=‘L’. The integer value of the ‘N’ bits is referred to herein as ‘Int’ and the integer value of the ‘M’ bits is referred to herein as ‘Res’.

The multiplier 334 may comprise suitable logic, circuitry, and/or code that may be operable to multiply the P-bit audio signal 321 by ‘LUTₒᵤₜ’, to generate the R-bit signal 335. Products generated by the multiplier 334 may be rounded and/or truncated. The values stored and/or retrieved from the LUT 332 may correspond to a gain between 0 and 1 and thus multiplication may correspond to an attenuation of the signal 321. The values stored and/or retrieved from the LUT 332 may correspond to a gain greater than 1 and thus multiplication may correspond to an amplification of the signal 321. The values stored and/or retrieved from the LUT 332, and thus whether the signal 321 is amplified or attenuated, may be selected based on a sign of the signal 327. In an exemplary embodiment of the invention, the components 324 and the signal 327 may be unsigned values and the values stored and retrieved from the LUT 332 may be configured by a system designer. In an exemplary embodiment of the invention, the multiplier 334 may be configurable to perform either multiplication or division. In such instances, multiplication or division may be chosen based on whether amplification or attenuation may be desired.

The bit-shift operation 336 may comprise suitable logic, circuitry, and/or code that may be operable to right shift or left shift values of the signal 335 by ‘Int’ bits. Left shift may be selected for amplifying the signal 335 and right shift may be selected for attenuating the signal 335. Amplification or attenuation may be selected based on a sign of the signal 327. Alternatively, the components 324 and the signal 327 may be unsigned and left shift or right shift may be selected by a system designer or may be configured via one or more control signals from, for example the DSP 154, the processor 156, or the memory 158.

The number conversion block 338 may comprise suitable logic, circuitry, and/or code that may be operable to truncate and/or pad the R-bit signal 337 to generate a P-bit audio signal 323. In an exemplary embodiment of the invention, gain values less than 1 may be converted to integers by multiplying the gain values by a constant. For example, for storage in the LUT 332, gain values between 0 and 1 may be multiplied by 32,768. Accordingly, the audio signal may be subsequently divided by 32,768 in order to obtain the proper attenuated value. In this regard, division by 32,768 may be achieved by truncating the 15 least significant bits of the signal 337.

In operation, the gain components 324₁, . . . , 324_{J} may be summed by the adder 326 and output as an overall gain value 327. In various embodiments of the invention, the sign of the overall gain value 327 may determine whether the digital gain block 322 amplifies or attenuates the audio signal 321. In other embodiments of the invention, whether the digital gain block 322 amplifies or attenuates the audio signal 321 may be pre-configured by system designers, or dynamically configured via one or more control signals from, for example, the DSP 154, the processor 156, or the memory 158. In instances that the overall gain value 327 is a signed value, the number conversion block 328 may convert the gain value 327 to an unsigned value and truncate it to ‘L’ bits. In instances that the overall gain value 327 is an unsigned value, the number conversion block 328 may truncate the overall gain value 327 to ‘L’ bits.

Once the overall gain value 329 is determined, the routing block 330, the LUT 332, the multiplier 334, and the bit-shift operation 336 may apply the gain to the audio signal 321. In this regard, gain value 329, in decibels, may be written as:

gain/attn₃₂₉(dB)=±(6.02*Int+(6.02/2^{M})*Res) EQ. 1

where ‘gain/attn₃₂₉’ is the value of the overall gain 329 and the plus and minus may correspond, respectively, to amplification and attenuation. EQ. 1 may be re-written in terms of a scalar value, rather than a dB value, as:

gain/attn₃₂₉=(10^{±0.05}*^{(6.02/2}^{^{M}}⁾*^{Res})*2^{±Int} EQ. 2

where ‘gain/attn₃₂₉’ is the value of the overall gain 329 and the plus and minus may correspond, respectively, to amplification and attenuation. Furthermore, if:

LUTₒᵤₜ=10^{±0.05}*^{(6.02/2}^{^{M}}⁾*^{Res} EQ. 3

where ‘LUTₒᵤₜ’ is the value retrieved from the LUT 332 based on the value of ‘Res’ and either the plus or the minus is used based on whether amplification or attenuation is desired, then scalar values for gain and attenuation may be written, respectively, as EQs. 4 and 5:

gain₃₂₉=LUTₒᵤₜ*2^{+Int} EQ. 4

attn₃₂₉=LUTₒᵤₜ*2^{-Int} EQ. 5

Thus, for amplification, the signal 321 may be multiplied by ‘LUTₒᵤₜ’ to generate the signal 335 and the signal 335 may be left shifted by ‘Int’ bits, which may be equivalent to multiplying it by 2^{Int}, to generate the signal 337. Similarly, for attenuation, the signal 321 may be multiplied by ‘LUTₒᵤₜ’ to generate the signal 335 and the signal 335 may be right shifted by ‘Int’ bits, which may be equivalent to multiplying it by 2^{-Int}, to generate the signal 337. The signal 337 may be truncated and/or padded such that the output signal 323 is a P-bit audio signal.

FIG. 3C is a block diagram illustrating an exemplary gain ramping block, in accordance with an embodiment of the invention. Referring to FIG. 3C the gain ramping block 622 may comprise a comparison block 642, a multiplier 644, an adder 646, a clamping block 648, and a register 650.

The comparison block 642 may comprise suitable logic, circuitry, and/or code that may be operable to compare a target gain value 625, ‘X’, to the gain component 324, ‘Y’. In instances that ‘X’ may be greater than ‘Y’, the comparison block 642 may output a value of +1 for flag 623. In instances that ‘X’ may be equal than ‘Y’, the comparison block 642 may output a value of 0 for flag 623. In instances that ‘X’ may be less than ‘Y’, the comparison block 642 may output a value of −1 for flag 623.

The multiplier 644 may comprise suitable logic, circuitry, and/or code that may be operable to multiply the output of the comparison block 642 by the slope 627 to generate the signal 645.

The adder 646 may comprise suitable logic, circuitry, and/or code that may be operable to add the signal 645 to the signal 651.

The clamping block 648 may comprise suitable logic, circuitry, and/or code that may be operable to prevent the gain component 324 from being set to a value outside a range determined by the target gain 625 and 0 dB.

The register 650 may comprise one or more storage elements, such as latches and/or flip flops, for storing the value of the gain component 324ᵢ₊₁.

The target gain 625 may be of the same bitwidth, L-bits, as the gain value 329 described with respect to FIG. 3B. The gain component 324ᵢ₊₁ may be a K bit signal, where K is larger than L. Accordingly, larger differences between K and L may correspond to longer ramping time. The actual ramp time may be determined by the slope 627.

In operation, register 650 may hold the current gain value, which may be the same as the target gain 625, and thus flag 623 may be 0. A new target which is different from the current gain value stored in 650 may be provided by, for example, hardware or software. Subsequently, the gain component may begin being updated, by the amount specified by slope 627, with each audio sample. The number of samples it takes to change the value in the L MSBs may depend on the slope 627 and may be limited by the difference between K and L. For example, if slope 627 is equal to 1, then it may take 2^{K-L} audio samples for the gain 329 to increment or decrement by 1. In general it may take (2^{K-L}/slope 627) audio samples for the gain 329 to increment or decrement by 1.

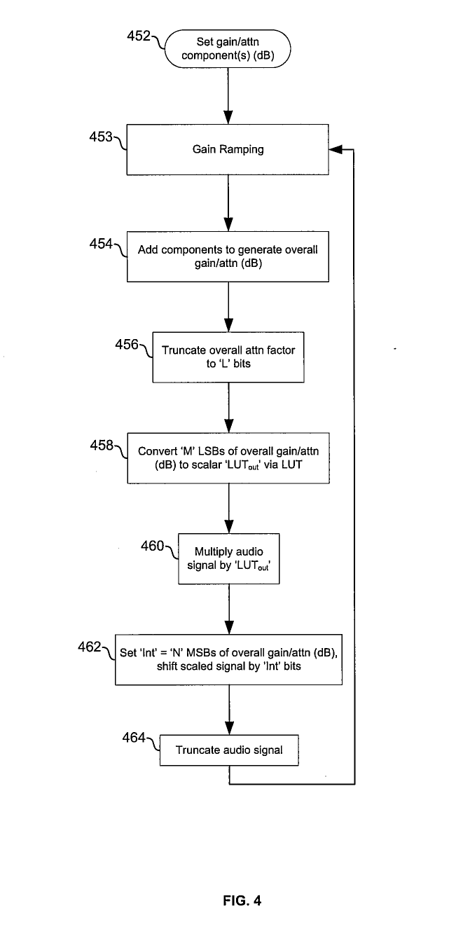

FIG. 4 is a flowchart illustrating exemplary steps for controlling audio signal levels, in accordance with an embodiment of the invention. Referring to FIG. 4, the exemplary steps may begin with step 452 when one or more of the gain components 324 may be set by, for example, the DSP 154, the processor 156, or hardware within the audio processing device 164. Subsequent to step 452, the exemplary steps may advance to step 453.

In step 453, one or more gain components 324 may be ramped up or down. Whether a ramping may occur may be indicated by the flag 423. In instances that the flag 423 is 1, the target gain 625 may be greater than the gain component 324 and the gain component(s) 324 may be ramped up by increasing the gain component(s) 324 by the slope 627. In instances that the flag 423 is −1, the target gain 625 may be less than the gain component 324 and the gain component(s) 324 may be ramped down by decreasing the gain component(s) 324 by the slope 627. In instances that the flag 423 is 0, the target gain 625 may be equal to the gain component 324 and gain ramping may be unnecessary. Subsequent to step 453, the exemplary steps may advance to step 454.

In step 454, the various gain components 324 may be summed to generate an overall gain value 327, which may be in dB. Subsequent to step 454, the exemplary steps may advance to step 456. In step 456, the overall gain may be converted to an L-bit unsigned dB value 329. Subsequent to step 456, the exemplary steps may advance to step 458.

In step 458, the ‘M’ least significant bits of the gain value 329, may be converted from a dB value to a scalar value, ‘LUTₒᵤₜ’, via the LUT 332. Subsequent to step 458, the exemplary steps may advance to step 460. In step 460, an audio signal may be multiplied by ‘LUTₒᵤₜ’ to generate the signal 335. Subsequent to step 460, the exemplary steps may advance to step 462. In step 462, a value ‘Int’ may be set equal to the ‘N’ most significant bits of the overall gain/attn value 329, and the scaled audio signal 335 may be shifted by ‘Int’ bits. In this regard, the scaled audio signal 335 may be left shifted when amplification may be desired and may be right shifted when attenuation may be desired. Subsequent to step 462, the exemplary steps may advance to step 464. In step 464, the scaled and shifted audio signal 335 may be truncated and/or padded to an appropriate number of bits and applied to the current audio sample.

At the next audio sample, the exemplary steps may return to step 453, and the gain component(s) 324 may again be increased or decreased by the amount of slope 627. Ramping up or down may continue with each subsequent audio sample until the flag 623 becomes 0.

Exemplary aspects of a method and system for digital gain control in an audio CODEC are provided. In certain embodiments of the invention, in a hardware audio CODEC 164, a plurality of gain values in decibels 324 may be generated and may be summed to generate an overall gain value in decibels 327. One or more of the gain values 324 may be ramped over a plurality of audio samples in order to prevent audible clicking or popping which may result from abrupt gain changes. The overall gain value in decibels 327 may then be utilized to scale one or more audio signals 321. The overall gain value in decibels 327 may be converted to an unsigned value in decibels 329 and whether the gain corresponds to amplification or attenuation may be determined based on a sign of the overall gain value in decibels 327 prior to the conversion. Each of the plurality of gain values in decibels 324 may be generated via software, firmware, and/or hardware. A first portion, “RES”, of the overall gain value in decibels 237 may be converted to a scalar and a remaining portion, “INT”, of the overall gain value in decibels 327 may be converted to a shift count. Accordingly, scaling may comprise multiplying one or more audio signals 231 by the scalar to generate one or more scaled audio signals 335 and shifting the one or more scaled audio signals 335 by a number of bits equal to the shift count. The scalar value may be determined via a look-up table 332 and may be selected from the look-up table 332 based on whether the audio signals 321 are to be amplified or attenuated. The first portion of the overall gain value in decibels 327 may comprise one or more least significant bits of the overall gain value in decibels 327. The remaining portion of the overall gain value in decibels 327 may comprise one or more most significant bits of the overall gain value in decibels 327.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for audio level detection and control.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. One embodiment may utilize a commercially available processor, which may be implemented external to an ASIC implementation of the present system. Alternatively, in an embodiment where the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for signal processing the method comprising:
in a hardware audio CODEC:
generating a plurality of gain values in decibels;
summing said plurality of gain values in decibels to generate an overall gain value in decibels; and
scaling one or more audio signals utilizing said generating overall gain value.

2. The method according to claim 1, comprising converting said overall gain value to an unsigned value in decibels.

3. The method according to claim 2, comprising determining whether said overall gain value corresponds to an amplification or an attenuation based on a sign of said overall gain value prior to said conversion.

4. The method according to claim 1, wherein each of said plurality of gain values are generated via one or more of software, firmware, and hardware

5. The method according to claim 1, wherein one or more of said plurality of gain values are incrementally increased or decreased over a plurality of audio samples.

6. The method according to claim 1, comprising converting a first portion of said overall gain value in decibels to a scalar and converting a remaining portion of said overall gain value in decibels to a shift count.

7. The method according to claim 6, comprising scaling said one or more audio signals by:
multiplying said one or more audio signals by said scalar to generate one or more scaled audio signals; and
shifting said scaled audio signal by a number of bits equal to said shift count.

8. The method according to claim 6, comprising converting said first portion of said overall gain value in decibels to said scalar via a look-up table.

9. The method according to claim 8, wherein said scalar retrieved from said look-up table is determined based on whether said one or more audio signals are to be amplified or attenuated.

10. The method according to claim 6, wherein said first portion of said overall gain value in decibels comprises one or more least significant bits of said overall gain value in decibels.

11. The method according to claim 6, wherein said remaining portion of said overall gain value in decibels comprises one or more most significant bits of said overall gain value in decibels.

12. A system for signal processing the method comprising:
one or more circuits for use in a hardware audio CODEC, said one or more circuits operable to:
generate a plurality of gain values in decibels;
sum said plurality of gain values in decibels to generate an overall gain value in decibels; and
scale one or more audio signals utilizing said generating overall gain value.

13. The system according to claim 12, wherein said one or more circuits are operable to convert said overall gain value in decibels to an unsigned value in decibels.

14. The system according to claim 13, wherein said one or more circuits are operable to determine whether said overall gain value in decibels corresponds to an amplification or an attenuation based on a sign of said overall gain value prior to said conversion.

15. The system according to claim 12, wherein each of said plurality of gain values in decibels are generated via one or more of software, firmware, and hardware.

16. The system according to claim 12, wherein one or more of said plurality of gain values are incrementally increased or decreased over a plurality of audio samples.

17. The system according to claim 12, wherein said one or more circuits are operable to convert a first portion of said overall gain value in decibels to a scalar and converting a remaining portion of said overall gain value in decibels to a shift count.

18. The system according to claim 17, wherein said one or more circuits are operable to scale said one or more audio signals by:
multiplying said one or more audio signals by said scalar to generate one or more scaled audio signals; and
shifting said scaled audio signal by a number of bits equal to said shift count.

19. The system according to claim 17, wherein said one or more circuits are operable to convert said first portion of said overall gain value in decibels to said scalar via a look-up table.

20. The system according to claim 19, wherein said scalar retrieved from said look-up table is determined based on whether said one or more audio signals are to be amplified or attenuated.

21. The system according to claim 17, wherein said first portion of said overall gain value in decibels comprises one or more least significant bits of said overall gain value in decibels.

22. The system according to claim 17, wherein said remaining portion of said overall gain value in decibels comprises one or more most significant bits of said overall gain value in decibels.
